(19) United States
(12) Patent Application Publication
(10) Pub. No.: US 2006/0293439 A1
(43) Pub. Date: Dec. 28, 2006

(54) Fluoroelastomer compositions, their preparation, and their use

(76) Inventor: Ray C. Hetherington, Virginia Beach, VA (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/158,424

(22) Filed: Jun. 22, 2005

(51) Int. Cl. C08L 27/12

(52) U.S. Cl. 524/544

(57) ABSTRACT

A curable fluoroelastomer composition comprising at least one fluoroelastomer, a bisphenol curative, a peroxide curative, and at least one silicone oil and/or silicone gum provides a non-post cure fluoroelastomer material suitable for use in the manufacture of, for example, sealing elements like O-rings, flange seals and gaskets, e.g., intake manifold gaskets, rocker cover gaskets, oil pan gaskets, plastic carrier gaskets, rubber to metal bonded gaskets, and the like, in which the cured composition exhibits improved elongation values at temperatures above 120° C. When cured (vulcanized), the composition exhibits an improved compression set resistance, in comparison to the fluoroelastomer cured by the bisphenol curative alone, without performing a post-cure procedure or with only performing a limited or reduced post-cure procedure of up to 2 hours, preferably not more than 1 hour (for example, 1-30 min.) at 175° C.-235° C. (e.g., 350° F.-450° F.).

### FIELD OF THE INVENTION

The invention relates to curable and cured fluoroelastomers and molded products made therefrom, particularly sealing elements such as gaskets used in the automotive industry.

### BACKGROUND OF THE INVENTION

Reducing the emissions of pollutants caused by the operation of internal combustion engines is a continuing goal of industry in general, and the automotive industry in particular. Developments in this area have been spurred on in part by federal and state legislations which set limits for the permissible levels of numerous gasses and other pollutants that result from internal combustion engines such as the gasoline burning engines used in automobiles. For example, California's Air Resources Board (ARB) adopted Low-Emission Vehicle (LEV) regulations in 1990. This set of regulations requires significant reductions in automobile emissions and run from 1994 to 2003. The ARB has since amended these regulations to impose even greater emission reduction requirements. These new regulations, LEV-II, will run from 2004 through 2010. LEV and LEV-II impose very stringent requirements on emissions from automobiles. Other relevant regulations are the U.S. Environmental Protection Agency National Low Emissions Vehicle (NLEV) standards. As a result, the automotive industry is continuously investigating ways to reduce emissions in order to comply with these and other legislative requirements.

Emissions from internal combustion engines include not only the resultant combustion gases, such as carbon monoxide, but also fuel emissions such as leakage of fuel vapors, e.g., gasoline vapors, during the transportation from a storage vessel (e.g., an automobile fuel tank) to the point of combustion (e.g., a gasoline engine). To reduce such emissions, gaskets and other sealing elements are used to seal joints. Such sealing elements are made from a variety of materials including polymers, fiber composites, graphite, and steel. Typical polymeric gasket materials used in automobiles include silicone rubbers, fluorosilicone rubbers, and HNBR rubber (hydrogenated acrylonitrile-butadiene rubber or hydrogenated nitrile rubber).

However, due to the demand for even lower emission levels, polymeric materials that exhibit even lower permeability to fuel vapors are being used, for example, fluoroelastomers (FKM). Typical examples of fluoroelastomers are copolymers of vinylidene fluoride and hexafluoropropylene and terpolymers of vinylidene fluoride, hexafluoropropylene and tetrafluoroethylene. These fluoroelastomers possess not only low fuel permeability, but also excellent heat stability, good resistance to solvents, oils, and other chemicals, low compression set, and good processability. However, fluoroelastomers are relatively expensive materials, and thus there is a need to reduce costs associated with the manufacture of molded articles such as gaskets from fluoroelastomers.

In the manufacture of molded articles from fluoroelastomers, a two step curing or vulcanization process is typically used. First, the articled is molded and undergoes an initial “within the mold” cure induced by the application of heat and pressure. Subsequently, the molded article undergoes a post cure step wherein the article is heated to, for example, 225° C. -250° C. and held at that temperature for a period of time, e.g., from about 12 up to 16 hours, or even up to 24 hours, sometimes even up to 48 hours.

This post-cure procedure greatly increases production time and costs. For this reason, the industry has sought curable fluoroelastomer compositions that exhibit low-post cure. One such material is Technoflon FOR HS® sold by Ausimont USA, which is said to provide a 75% reduction in post cure rate. This material is a 66% fluorine fluorocarbon elastomer combined with a bisphenol curative. In this material, hygroscopic end groups are eliminated in the polymer backbone which results in improved compression set because the ionic forces of the end groups, which tend to adversely affect compression set, are mitigated. While this material does exhibit shorter post cure times, there is still a need for materials with even lower post cure times, more particularly there is a need for materials that can be characterized as non-post cure materials.

U.S. patent application Ser. Nos. 10/440,168 and 11/046,862 describe a curable fluoroelastomer composition comprising at least one fluoroelastomer, a bisphenol curative, and a peroxide curative, wherein when cured (vulcanized) the material exhibits an improved compression set resistance, in comparison to the fluoroelastomer cured by the bisphenol curative alone, Preferably, the fluoroelastomer composition does not require any post cure procedure. However, the composition can be subjected to a reduced post cure at 175° C.-235° C. (e.g., 350° F.-450° F.) of up to 2 hours, preferably not more than 1 hour (for example, 30 min. at 380° F.).

However, another desirable property for fluoroelastomer composition used to make sealing elements such as gaskets is to exhibit high elongation values at elevated temperatures. Low elongation values at temperatures associate with the operation of gasoline engines can lead to cracks developing in the sealing elements such as the intake manifold seals. Thus, an increase in elongation values will reduce the occurrence of sealing element failures.

### SUMMARY OF THE INVENTION

Accordingly, an aim of the invention is to provide a curable fluoroelastomer composition containing a bisphenol/peroxide cure system exhibits a reduced post cure time, and possesses high elongation values at elevated temperatures.

Upon further study of the specification and appended claims, further advantages of this invention will become apparent to those skilled in the art.

In accordance with the invention there is provided a curable fluoroelastomer composition comprising at least one fluoroelastomer, a bisphenol curative, a peroxide curative, and a silicone oil and/or silicone gum, wherein when cured (vulcanized) the material exhibits an improved compression set resistance, in comparison to the fluoroelastomer cured by the bisphenol curative alone, preferably without performing a post-cure procedure or with only performing a limited or reduced post-cure procedure of up to 2 hours, preferably not more than 1 hour (for example, 1-30 min.) at 175° C.-235° C. (e.g., 350° F.-450° F.), and which when cured exhibits an enhanced elongation value at temperatures above 120° C., preferably above 130° C., for example, 135° C.

In particular, the invention relates to combining a silicone oil and/or silicone gum with the curable fluoroelastomer compositions disclosed U.S. patent application Ser. Nos. 10/440,168 and/or 11/046,862, the disclosures of which are hereby incorporated by reference, in an amount effective to increase the elongation values thereof at temperatures above 120° C., preferably above 130° C., to more than 140%, especially more than 150%, e.g., 150-160%.

Thus, in accordance with an aspect of the invention there is provided a curable fluoroelastomer composition comprising on or more fluoroelastomers, at least one bisphenol curative, at least one peroxide curative, and at least one silicone oil and/or silicone gum, wherein the at least one silicone oil and/or silicone gum is present in an amount sufficient to achieve an elongation of at least 140% at a temperature above 120° C. for the resultant cured fluoroelastomer composition. Preferably, the composition further comprises at least one filler.

According to a further aspect of the invention there is provided a cured molded fluoroelastomer composition comprising:

an elastomeric component consisting essentially of one or more fluoroelastomers,

at least one bisphenol curative,

at least one peroxide curative, and

an at least one silicone oil and/or silicone gum,

wherein said one or more fluoroelastomers is a homopolymer or a copolymer in which the monomer units are selected from vinylidene fluoride, hexafluoropropylene, tetrafluoroethylene, chlorotrifluorethylene, and perfluoro (alkyl vinyl ether),

wherein said cured molded fluoroelastomer is obtained by curing the uncured fluoroelastomer composition under pressure within a mold at a temperature of at least 160° C. and a pressure of at least 5,000 psi for at least 90 seconds, followed by no subsequent post cure procedure or followed by a post cure procedure wherein the composition is subjected to a temperature of 175° C.-235° C. for up to 2 hours, and

wherein the at least one silicone oil and/or silicone gum is present in an amount sufficient to achieve an elongation of at least 140% at a temperature above 120° C. for the resultant cured fluoroelastomer composition. Preferably, the composition further comprises at least one filler.

According to a further aspect of the invention there is provided a sealing element comprising a cured fluoroelastomer composition comprising:

an elastomeric component consisting essentially of one or more fluoroelastomers,

at least one bisphenol curative,

at least one peroxide curative,

a monomeric ester plasticizer, and

at least one silicone oil and/or silicone gum,

wherein the at least one silicone oil and/or silicone gum is present in an amount sufficient to achieve an elongation of at least 140% at a temperature above 120° C. for the resultant cured fluoroelastomer composition, and

wherein said one or more fluoroelastomers is a homopolymer or a copolymer in which the monomer units are selected from vinylidene fluoride, hexafluoropropylene, tetrafluoroethylene, chlorotrifluorethylene, and perfluoro (alkyl vinyl ether). Preferably, the composition further comprises at least one filler.

According to a further aspect of the invention there is provided a process for preparing a cured molded fluoroelastomer composition, the process consisting essentially of:

curing a fluoroelastomer composition under pressure within a mold at a temperature of at least 160° C. and a pressure of at least 5,000 psi for at least 90 seconds, and then either not subjecting the composition to a post cure procedure or subjecting the composition to a post cure procedure wherein the composition is subjected to a temperature of 175° C.-235° C. for up to 2 hour,

wherein said fluoroelastomer composition comprises:
an elastomeric component consisting essentially of one or more fluoroelastomers,
at least one bisphenol curative,
at least one peroxide curative, and
at least one silicone oil and/or silicone gum present in an amount sufficient to achieve an elongation of at least 140% at a temperature above 120° C. for the resultant cured fluoroelastomer composition. Preferably, the composition further comprises at least one filler.

According to a further aspect of the invention there is provided a process for post curing a molded fluoroelastomer composition, the process consisting essentially of:

subjecting a fluoroelastomer composition, which has previously been subject to an initial curing at a temperature of at least 160° C. and a pressure of at least 5,000 psi for at least 90 seconds, to a post cure procedure wherein the composition is subjected to a temperature of 175° C.-235° C. for up to 2 hour,

wherein said fluoroelastomer composition comprises:
an elastomeric component consisting essentially of one or more fluoroelastomers,
at least one bisphenol curative,
at least one peroxide curative, and
at least one silicone oil and/or silicone gum present in an amount sufficient to achieve an elongation of at least 140% at a temperature above 120° C. for the resultant cured fluoroelastomer composition. Preferably, the composition further comprises at least one filler.

According to a further aspect of the invention there is provided a process for preparing a fluoroelastomer composition, comprising:

combining one or more fluoroelastomer and at least one bisphenol curative with an amount of filler,

adding an amount of the at least one silicone oil and/or silicone gum to wet the filler, and then adding the remainder of the filler,

stirring the resultant mixture, and

adding to the mixture at least one peroxide curative, and optionally, at least one monomeric ester plasticizer.

In accordance with a further aspect of the invention, a monomeric ester plasticizer is added to the curable fluoroelastomer composition which comprises at least one fluoroelastomer, a bisphenol curative, a peroxide curative, and at least one silicone oil and/or silicone gum. The plasticizer reduces the viscosity of the composition thereby facilitating molding. In addition, the resultant molded composition exhibits improved low temperature retraction. In this embodiment, it is preferred that the peroxide curative is in liquid form and that the plasticizer and peroxide are added together to the fluoroelastomer composition.

With respect to the reduced post cure, while not being bound to any particular theory as to the mechanism involved, it is believed that the two curative components provide a two stage cure. In the initial stage, the bisphenol provides a first level or primary cross-linking. During this stage, cross-linkng from the peroxide is not believed to be substantial. Near the end of this initial stage, the rate of cross-linking from the bisphenol curative decreases. The second cure stage then starts. In this stage, it is believed that the peroxide cure neutralizes or deactivates the bisphenol cure and provides a secondary cross-linking reaction. Deactivation of the bisphenol curative prevents additional primary cross-linking under compression which can lead to poor compression set characteristics. Alternatively or, in addition, the peroxide may act in conjunction with the bisphenol and/or act as an H₂O scavenger to eliminate the ionic effects of H₂O on the fluoroelastomer polymer chain, thereby either eliminating the need to perform a post cure or permitting a reduction in the post cure procedure as described above and below. In any event, the procedure provides a cured fluoroelastomer having a higher degree of cross-linking and a markedly improved compression set resistance without performing a traditional post cure step of heating (for example, heating to about 225° C. for about 12 to 16 hours).

Through the use of the inventive curable fluoroelastomer composition, the manufacturing process is simplified by either reducing the post cure procedure to up to 2 hours, preferably not more than 1 hour (for example, 1-30 min.) at 175° C.-235° C. (e.g., 350° F.-450° F.), or by eliminating the post cure manufacturing step altogether. This, of course, results in lower manufacturing costs and reduces the manufacturing time. In addition, by eliminating or reducing the post-cure step, the manufacturing process moves further towards a continuous process, and away from a batch process, which increases efficiency and production rate.

The inventive composition is particularly useful for the manufacture of sealing elements like O-rings, flange seals and gaskets, e.g., intake manifold gaskets, rocker cover gaskets, oil pan gaskets, plastic carrier gaskets, rubber to metal bonded gaskets, and the like. The materials are especially well suited for use as gaskets that require low fuel permeation.

In accordance with a particular embodiment, the inventive composition is used to manufacture intake manifold gaskets which seal the joint between the intake manifold and the cylinder head of the engine. Such gaskets can be manufactured separately (so-called “press-in-place” gaskets) or can be molded onto a carrier. In the latter case, the inventive composition provides a further advantage. In prior gasket materials that required a traditional post-cure step, the carrier onto which the gasket is molded had to be constructed from materials that could withstand the traditional post cure temperatures. For this reason, the carriers used were often made form expensive heat resistant materials such as polyamide (PA) 6/6. However, with the materials according to the invention, less expensive, lower heat resistant materials (e.g., materials with a Tg (glass transition temperature) of around 200° C. or less, such as 150° C. to 200° C.) can be used for the carrier such as PA 4/6 and polyether sulfone. This results in further reductions in manufacturing costs.

The at least one silicone oil or silicone gum is preferably a low viscosity dimethyl silicone oil (dimethicone) or a dimethyl silicone gum, for example, the silicone oil SF96-50 manufactured by General Electric (viscosity=50 centipoise) or the silicone gum OMNI-Sil 776 (manufactured by OMNI-Sil Technologies, Inc., specific gravity 0.97+/−0.02).

The fluoroelastomers suitable for use in the disclosed invention are elastomers that comprise one or more vinylidene fluoride units (VF₂ or VdF), one or more hexafluoropropylene units (HFP), one or more tetrafluoroethylene units (TFE), one or more chlorotrifluoroethylene (CTFE) units, and/or one or more perfluoro(alkyl vinyl ether) units (PAVE) such as perfluoro(methyl vinyl ether)(PMVE), perfluoro(ethyl vinyl ether)(PEVE), and perfluoro(propyl vinyl ether)(PPVE). These elastomers can be homopolymers or copolymers. Particularly suitable are fluoroelastomers containing vinylidene fluoride units, hexafluoropropylene units, and, optionally, tetrafluoroethylene units and fluoroelastomers containing vinylidene fluoride units, perfluoroalkyl perfluorovinyl ether units, and tetrafluoroethylene units. Especially suitable are copolymers of vinylidene fluoride and hexafluoropropylene units.

If the fluoropolymers contain vinylidene fluoride units, preferably the polymers contain up to 40 mole % VF2 units, e.g., 30-40 mole %. If the fluoropolymers contain hexafluoropropylene units, preferably the polymers contain up to 70 mole % HFP units. If the fluoropolymers contain tetrafluoroethylene units, preferably the polymers contain up to 10 mole % TFE units. When the fluoropolymers contain chlorotrifluoroethylene preferably the polymers contain up to 10 mole % CTFE units. When the fluoropolymers contain perfluoro(methyl vinyl ether) units, preferably the polymers contain up to 5 mole % PMVE units. When the fluoropolymers contain perfluoro(ethyl vinyl ether) units, preferably the polymers contain up to 5 mole % PEVE units. When the fluoropolymers contain perfluoro(propyl vinyl ether) units, preferably the polymers contain up to 5 mole % PPVE units. The fluoropolymers preferably contain 66%-70% fluorine.

The viscosity of the fluoropolymers can vary. Preferably, the fluoropolymers have a Mooney viscosity of 20-40.

These polymers have a certain amount of iodine and/or bromine (e.g., 0.01-5 wt %) for use with peroxide cures.

One suitable commercially available fluoroelastomer is Technoflon FOR HS® sold by Ausimont USA. This material contains Bisphenol AF, manufactured by Halocarbon Products Corp. Another commercially available fluoroelastomer is Viton® AL 200, by DuPont Dow, which is a terpolymer of VF2, HFP, and TFE monomers containing 67% fluorine. Another suitable commercially available fluoroelastomer is Viton® AL 300, by DuPont Dow. A blend of the terpolymers Viton® AL 300 and Viton® AL 600 can also be used (e.g., one-third AL-600 and two-thirds AL-300).

The bisphenol curing agent provides crosslinking through basic nucleophile (nucleophilic addition) curing. The bisphenol is used in conjunction with an accelerator, such as an organophosphonium salt. See, e.g., U.S. Pat. No. 4,272,179 and “Viton Fluoroelastomer Crosslinking by Bisphenols,” W. W. Schmiegel, South German Meeting of Deustche Kaustschuck Und Gummi Gesellschaft, Apr. 28-29, 1977. In nucleophilic addition, the bisphenol curing agent forms a covalently crosslinked network as a result of heating following basic dehydrofluorination.

Bisphenol curing agents that can be used in the invention are those known within the art as being suitable for use with fluoroelastomers. See, e.g., U.S. Pat. No. 6,239,469. In general, the bisphenol crosslinking agent is used in amounts of from about 0.5-4 parts by weight per hundred parts by weight fluoroelastomer (phr), preferably 1-2.5 phr.

Suitable bisphenols include those disclosed by U.S. Pat. No. 6,239,469, e.g., bisphenols of the formula: 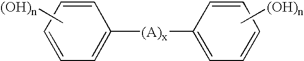
wherein

A is a stable divalent radical, such as a difunctional aliphatic, cycloaliphatic, or aromatic radical, in each case having up to 1-13 carbon atoms, or a thio, oxy, carbonyl, sulfinyl, or sulfonyl radical, and A is optionally substituted with at least one chlorine or fluorine atom;

x is 0 or 1;

n is 1 or 2; and

any aromatic ring of the polyhydroxylic compound is optionally substituted with at least one atom of chlorine, fluorine, bromine, —CHO, or a carboxyl or acyl radical (e.g., —COR wherein R is OH, C₁₋₈-alkyl, aryl, or cycloalkyl). Combinations of two or more such bisphenol compounds can also be used.

Suitable A groups are alkylene, alkylidene, cycloalkylene, and arylene groups, for example, methylene, ethylene, chloroethylene, fluoroethylene, difluoroethylene, 1,3-propylene, 1,2-propylene, tetramethylene, chlorotetramethylene, fluorotetramethylene, trifluorotetramethylene, 2-methyl-1,3-propylene, 2-methyl-1,2-propylene, pentamethylene, hexamethylene, ethylidene, dichloroethylidene, difluoroethylidene, propylidene, isopropylidene, trifluoroisopropylidene, hexafluoroisopropylidene, butylidene, heptachlorobutylidene, heptafluorobutylidene, pentylidene, hexylidene, 1,1-cyclohexylidene, 1,4-cyclohexylene, 2-chloro-1,4-cyclohexylene, 2-fluoro-1,4-cyclohexylene, 1,3-cyclohexylene, cyclopentylene, chlorocyclopentylene, fluorocyclopentylene, cycloheptylene, m-phenylene, p-phenylene, 2-chloro-1,4-phenylene, 2-fluoro-1,4-phenylene, o-phenylene, methylphenylene, dimethylphenylene, trimethylphenylene, tetramethylphenylene, 1,4-naphthylene, 3-fluoro-1,4-naphthylene, 5-chloro-1,4-naphthylene, 1,5-naphthylene, and 2,6-naphthylene.

To provide for the vulcanization/curing in accordance with the invention, the peroxides are preferably high temperature peroxides, that is they have a slower decomposition half life. The use of such peroxides permits the bisphenol curing reactions to proceed for a sufficient amount of time before the peroxide cure begins. This prevents the occurrence of competing curing reaction which can result in unsatisfactory or even un-useable materials. For example, tests with valerate peroxide and dicumyl peroxide on certain fluoroelastomer/bisphenol composition were unsuccessful (Technoflon FOR HS® and is Viton® AL 200). These two peroxides have faster half life decompositions and start curing at around 88 to 116° C. Thus, these peroxides may be unsuitable unless used with a bisphenol cure that has a fast reaction rate. Preferably, the peroxides for use in the invention start curing at temperatures of about 170° C.-180° C.

The amount of peroxide cure to be used can vary and optimal amounts can be determined through routine experimentation. In general, about 0.05-5 phr (parts per hundred parts by weight of fluoroelastomer) of peroxide are used, preferably 0.1 to 3 parts by weight phr. While typically only one peroxide is used, it is also possible to combine more than one peroxide. The peroxide may be adsorbed on an inert carrier, the weight of which is not included in the above mentioned range for the amount of peroxide. In the case of Perkadox® 14/40, the amount of this peroxide cure is preferably 1±0.3% of the total weight of the composition. In the case of Varox® DBPH (liquid form), the amount of this peroxide cure is preferably 0.75-2% of the total weight of the composition.

Peroxides useful as curing agents in the practice of the present invention include tert-butylcumyl peroxide (e.g., Trigonox® T), 2,5-dimethyl-2,5-di(t-butylperoxy) hexyne-3,2,5-dimethyl-2,5-di-(tert-butylperoxy)hexane (e.g., Trigonox® 101), alpha,alpha-bis(tert-butylperoxy-isopropyl)benzene (Perkadox® 14/40 and Perkadox® 14 (without carrier)), and 2,5-dimethyl-2,5-di(t-butyl-peroxy)hexane (Varox® DBPH-50 or Varox® DBPH (liquid form)). Another suitable peroxide is 25 Tri DYBP (with or without carrier).

The addition of a monomeric ester plasticizer to the curable fluoroelastomer composition can provide advantageous results with regards to viscosity and low-temperature properties. The amount of plasticizer used is preferably 3 to 7 per 100 parts of the fluoroelastomer, especially 4 to 6 per 100 parts of the fluoroelastomer. A preferred plasticizer is pentaerythritol ester (e.g., Hercoflex 600) [Hercules, Aqualon Division]. In a preferred embodiment, pentaerythritol ester is used in combination with and 2,5-dimethyl-2,5-di(t-butyl-peroxy)hexane (Varox® DBPH in liquid form).

The use of a plasticizer, for example, Hercoflex 600 in combination with Varox® DBPH in liquid form, is believed to enhance the penetration and distribution of the peroxide into the fluoroelastomer. Preferably, the peroxide is dissolved into the plasticizer and then combined with the fluoroelastomer.

A co-vulcanizing agent can be used in combination with the peroxide. Examples of co-vulcanizing agents include triallyl cyanurate, trimethally isocyanurate, triallyl isocyanurate (TAIC), triacrylformal, triallyl trimellitate, N,N′-m-phenylenebismaleimide, diallyl phthalate, tetrallylterephthalamide, tris(diallylamine)-s-triazine, triallyl phosphate, N,N,N′,N′-tetrallyl-malonamide; trivinyl-isocyanurate; 2,4,6-trivinyl-methyltrisiloxane; N,N′bisallylbicyclo-oct-7-ene-disuccinimide (BOSA), and N,N-diallylacrylamide. Generally, the co-vulcanizing agent is used in an amount of 0.1 to 10 parts by weight per 100 parts by weight of the fluoroelastomer.

In additional to the above described components, the compositions according to the invention can optionally contain additives conventionally used in elastomeric compositions, e.g., activators, fillers, dyes/coloring agents/pigments, release agents, metal compounds, lubricants, retarding agents, thickeners, antioxidants, stabilizers, plasticizers, processing aids, etc. For example, the composition can contain up to up to about 50% of one or more fillers, up to about 10% of one or more activators, up to about 1.5% of one or more dyes/coloring agents/pigments, and/or up to about 0.3% of one or more release agents.

Suitable fillers include carbon black, graphite, silica, clay, diatomaceous earthy, talc, wollastonite calcium carbonate, calcium silicate, calcium fluoride, barium sulfate, and the like. These fillers can be used alone or in combination. Typical coloring agents include titanium oxide, iron oxide, and the like. These can be present in amounts up to 10% by weight.

The compositions according to the invention can be prepared by combining the components, elastomer, bisphenol curative, peroxide curative and optional additives, for example, by Banbury mixer or pressure kneader. The resultant composition is then molded (compression molded, transfer injection molding, injection molding, etc.) and subjected to heat and pressure to perform the primary curing (vulcanization), i.e., subjected to a temperature of at least about 160° C. (for example, 160-200° C., preferably 175-200° C. such as 345-350° F.) about 175 to 200° C. and a pressure of at least about 5,000 psi (for example, 5,000-25,000 psi, preferably 10,000 to 20,000 psi) for at least about 90 seconds (for example, 90-240 seconds, preferably 140-240 seconds).

As noted above, a secondary vulcanization or post-cure is preferably not necessary. However, it may be desirable to perform a limited or reduced post-cure procedure, for example, as a safety precaution to ensure complete vulcanization. This reduced post-cure involves subjecting the composition to a temperature of 175° C.-235° C., for example, 350° F.-450° F. (176.7° C.-232.2° C.), preferably 350° F. 400° F., especially 370° F.-390° F. (e.g. 380° F.), for up to 2 hours (e.g., 1 min. to 2 hours), preferably not more than 1 hour (e.g., 1 min. to 1 hour), especially 1-40 min (for example, 5-40 min., 10-40 min., 10-30 min., 20-30 min. or 25-30 min.).

In the foregoing and in the following examples, all temperatures are set forth uncorrected in degrees Celsius; and, unless otherwise indicated, all parts and percentages are by weight.

The entire disclosure of all applications, patents and publications, cited above and below, is hereby incorporated by reference.

### EXAMPLES

### Examples 1-5

| | Example No. | | | | | |
|---|---|---|---|---|---|---|
| | 1 | 2 | 3 | 4 | 5 | Control |
| Technoflon FOR 50HS | 100 | 100 | 100 | 100 | 100 | 100 |
| (66% fluorine | parts | parts | parts | parts | parts | parts |
| copolymer | | | | | | |
| with bisphenol cure | | | | | | |
| incorporated; | | | | | | |
| Ausimont USA) | | | | | | |
| Elastomag 170 | 9 | 9 | 9 | 9 | 9 | 9 |
| (magnesium oxide) | | | | | | |
| Blanc Fixe Micros | 60 | 60 | 60 | 60 | 60 | 60 |
| (barium sulfate) | | | | | | |
| Akrochem 414 Green | 1 | 1 | 1 | 1 | 1 | 1 |
| (pigment) | | | | | | |
| Titanium Dioxide | 1 | 1 | 1 | 1 | 1 | 1 |
| (pigment) | | | | | | |
| Strucktol WS280 | 0.5 | 0.5 | 0.5 | 0.5 | 0.5 | 0.5 |
| powder (release aid) | | | | | | |
| Carnauba Wax | 0.5 | 0.5 | 0.5 | 0.5 | 0.5 | 0.5 |
| (release aid) | | | | | | |
| Hercoflex 600 | 1.25 | 1.25 | 1.25 | 1.25 | 1.25 | 1.25 |
| (plasticizer) | | | | | | |
| Varox DBPH liquid | 0.25 | 0.25 | 0.25 | 0.25 | 0.25 | 0.25 |
| (peroxide) | | | | | | |
| GE SF96-50 fluid | 0.25 | 0.5 | 1 | 1.5 | 2 | 0 |
| (silicone oil) | | | | | | |

All amounts in parts by weight.

The elongation is measured according to ASTM-D412, method A, at a temperature of 135° C. This test evaluates residual elongation of a test sample after being stretched and allowed to relax in the specified manner. This elongation consists of both permanent and recoverable components. In accordance with the test procedure, test samples are die cut from large sheets. In this case, the sample specimens are of the “die C” type wherein the dimensions are an overall length of 115 mm with a narrow section 33 mm long. This provides a gauge length of 25 mm long and a gauge width of 6 mm. Two marks are placed on each test sample at the ends of the gauge length of the dumbbell shaped specimens. The initial length between these marks is measured for each sample. The samples are carefully mounted in the test fixture to provide uniform alignment and position. The fixture stretches the samples and the elongation at break is determined.

For control sample, the elongation measured at 135° C. is in the range of 61-66%. For Example 1, no change in elongation is observed in comparison to the control sample. For Example 2, the elongation is about 160% (range 150-170%) and the tensile strength is 9.2 MPa. For Example 3, the elongation at break is 120%, but this occurs with a concomitant drop off in tensile strength properties (tensile strength is 7.8 MPa). For Examples 4 and 5 the elongation value continues to decrease (60% and 70%) and the tensile properties continue to drop off (6-7 MPa).

### Example 6

The following example describes preparation of the fluoroelastomer composition.

The following components are combined to form the masterbatch:

| MasterBatch | Weight (grams) |
|---|---|
| Technoflon FOR 50HS | 100 |
| (66% fluorine copolymer | |
| with bisphenol cure | |
| incorporated; Ausimont | |
| USA) | |
| Elastomag 170 | 9 |
| Blanc Fixe Micros | 60 |
| Akrochem 414 Green | 1 |
| Titanium Dioxide | 1 |
| Strucktol WS280 powder | 0.5 |
| (release aid) | |
| Carnauba Wax | 0.5 |
| GE SF96-50 | 0.5 |
| Total Weight | 172 |

In preparing this masterbatch, the components are combined as follows: The FKM polymer is introduced into a mixer and stirred for about 1 minute. Then, for example, about half the amount of barium sulfate filler is added, then the silicone oil is added so that the filler is wetted by the silicone oil. Thereafter, the remainder of the filler is added and the mixture is stirred for about three minutes. Next, the dye, release aid, and peroxide are added and stirred for about a minute. The batch is removed from the mixer after a total mixing time of about 5 to 6 minutes at a temperature of 230° F.-235° F.

To this masterbatch is added 0.25 gm of liquid 2,5-dimethyl-2,5-di(t-butyl-peroxy)hexene (Varox® DBPH, manufactured by R. T. Vanderbilt Co.) and 1.25 gm of pentaerytlritol ester (Hercoflex 600).

The material were tested as follows. ASTM slabs were prepared per ASTM D2000 Compression set samples were prepared per (ISO 815/ASTM D395), and plied button compressed 25% tested 22 hours at 175° C. The sample yielded 25-30% compression set. Due to the addition of the plasticizer, pentaerythritol ester, the composition viscosity was 26,000 centipoise.

### Example 7

A fluoroelastomer composition, as prepared in Example 6, is molded into the form of an intake manifold gasket by injection molding onto a nylon carrier. The fluoroelastomer composition is then subjected to an initially curing within the mold at a pressure of 10,000 to 20,000 psi and a temperature of 345° F.-350° F. for 100 seconds minutes. Thereafter, the composition is subjected to a post cure at 380° F. for 30 minutes.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A curable fluoroelastomer composition comprising one or more fluoroelastomer, at least one bisphenol curative, at least one peroxide curative, at least one filler, and at least one silicone oil and/or silicone gum, wherein said silicone oil and/or silicone gum is present in an amount sufficient to achieve an elongation of at least 140% at a temperature of 135° C. for the cured fluoroelastomer composition.

2. A curable fluoroelastomer composition according to claim 1, further comprising at least monomeric ester plasticizer.

3. A curable fluoroelastomer composition according to claim 1, wherein said one or more fluoroelastomers is a homopolymer or a copolymer in which the monomer units are selected from vinylidene fluoride, hexafluoropropylene, tetrafluoroethylene, chlorotrifluorethylene, and perfluoro (alkyl vinyl ether).

4. A curable fluoroelastomer composition comprising:
an elastomeric component consisting essentially of one or more fluoroelastomers at least one bisphenol curative,
at least one peroxide curative,
a monomeric ester plasticizer,
at least one filler, and
at least one silicone oil and/or silicone gum,
wherein said at least one silicone oil and/or silicone gum is present in an amount sufficient to achieve an elongation of at least 140% at a temperature of 135° C. for the cured fluoroelastomer composition, and
wherein said one or more fluoroelastomers is a homopolymer or a copolymer in which the monomer units are selected from vinylidene fluoride, hexafluoropropylene, tetrafluoroethylene, chlorotrifluorethylene, and perfluoro (alkyl vinyl ether).

5. A curable fluoroelastomer composition according to claim 1, wherein said perfluoro(alkyl vinyl ether) units are selected from perfluoro(methyl vinyl ether)(PMVE), perfluoro(ethyl vinyl ether)(PEVE), and perfluoro(propyl vinyl ether)(PPVE) units.

6. A curable fluoroelastomer composition according to claim 1, wherein said one or more fluoroelastomers contains vinylidene fluoride units, hexafluoropropylene units, and, optionally, tetrafluoroethylene units.

7. A curable fluoroelastomer composition according to claim 1, wherein said one or more fluoroelastomers contains vinylidene fluoride units, perfluoro(alkyl vinyl ether) units, and tetrafluoroethylene units.

8. A curable fluoroelastomer composition according to claim 1, wherein said one or more fluoroelastomers is a copolymer of vinylidene fluoride and hexafluoropropylene units.

9. A curable fluoroelastomer composition according to claim 1, wherein said one or more fluoroelastomers is a terpolymer of vinylidene fluoride, hexafluoropropylene, and tetrafluoroethylene monomers.

10. A curable fluoroelastomer composition according to claim 1, wherein said one or more fluoroelastomers contains 66-70% fluorine.

11. A curable fluoroelastomer composition according to claim 1, wherein said composition contains said bisphenol in an amount of 0.5-4 parts by weight per hundred parts by weight fluoroelastomer.

12. A curable fluoroelastomer composition according to claim 1, wherein the amount of peroxide cure is 0.05-5 parts per hundred parts by weight of fluoroelastomer.

13. A curable fluoroelastomer composition according to claim 1, wherein the amount of peroxide cure is 0.1 to 3 parts per hundred parts by weight of fluoroelastomer.

14. A curable fluoroelastomer composition according to claim 1, wherein the peroxide is tert-butylcumyl peroxide, alpha,alpha-bis(tert-butylperoxy-isopropyl)benzene, or 2,5-dimethyl-2,5-di(t-butyl-peroxy)hexane.

15. A curable fluoroelastomer composition according to claim 2, wherein the amount of monomeric ester plasticizer is 3 to 7 per 100 parts of the fluoroelastomer.

16. A curable fluoroelastomer composition according to claim 15, wherein the amount of monomeric ester plasticizer is 4 to 6 per 100 parts of the fluoroelastomer.

17. A curable fluoroelastomer composition according to claim 2, wherein the monomeric ester plasticizer is pentaerythritol ester.

18. A curable fluoroelastomer composition according to claim 1, wherein said at least one silicone oil and/or silicone gum is a dimethyl silicone oil (dimethicone) or a dimethyl silicone gum.

19. A curable fluoroelastomer composition according 18, wherein said at least one silicone oil and/or silicone gum is dimethyl silicone oil having a viscosity of 50 centipoise.

20. A sealing element comprising a cured fluoroelastomer composition comprising:
an elastomeric component consisting essentially of one or more fluoroelastomers,
at least one bisphenol curative,
at least one peroxide curative,
a monomeric ester plasticizer,
at least one filler, and
at least one silicone oil and/or silicone gum,
wherein said at least one silicone oil and/or silicone gum is present in an amount sufficient to achieve an elongation of at least 140% at a temperature above 120° C. for the resultant cured fluoroelastomer composition, and
wherein said one or more fluoroelastomers is a homopolymer or a copolymer in which the monomer units are selected from vinylidene fluoride, hexafluoropropylene, tetrafluoroethylene, chlorotrifluorethylene, and perfluoro (alkyl vinyl ether).

21. A process for preparing a cured molded fluoroelastomer composition, the process consisting essentially of:
curing a fluoroelastomer composition under pressure within a mold at a temperature of at least 160° C. and a pressure of at least 5,000 psi for at least 90 seconds, and then either not subjecting the composition to a post cure procedure or subjecting the composition to a post cure procedure wherein the composition is subjected to a temperature of 175° C.-235° C. for up to 2 hour,
wherein said fluoroelastomer composition comprises:
an elastomeric component consisting essentially of one or more fluoroelastomers,
at least one bisphenol curative,
at least one peroxide curative,
at least one filler, and
at least one silicone oil and/or silicone gum present in an amount sufficient to achieve an elongation of at least 140% at a temperature above 120° C. for the resultant cured fluoroelastomer composition.

22. A process for post curing a molded fluoroelastomer composition, the process consisting essentially of:
subjecting a fluoroelastomer composition, which has previously been subject to an initial curing at a temperature of at least 160° C. and a pressure of at least 5,000 psi for at least 90 seconds, to a post cure procedure wherein the composition is subjected to a temperature of 175° C.-235° C. for up to 2 hour,
wherein said fluoroelastomer composition comprises:
an elastomeric component consisting essentially of one or more fluoroelastomers,
at least one bisphenol curative,
at least one peroxide curative,
at least one filler, and
at least one silicone oil and/or silicone gum present in an amount sufficient to achieve an elongation of at least 140% at a temperature above 120° C. for the resultant cured fluoroelastomer composition.

23. A method of preparing a composition according to claim 1, comprising
combining the one or more fluoroelastomer and the at least one bisphenol curative with an amount of the filler,
adding an amount of the at least one silicone oil and/or silicone gum to wet the filler, and then adding the remainder of the filler,
stirring the resultant mixture, and
adding to the mixture the at least one peroxide curative.
